(19) United States
(12) Patent Application Publication
(10) Pub. No.: US 2022/0063162 A1
(43) Pub. Date: Mar. 3, 2022

(54) INJECTION MOLD WITH INTERNAL SEPARATOR FOR MOLDING PROCESSES

(71) Applicant: National Polymer International Corporation, Inc., Plano, TX (US)

(72) Inventor: Steven Ho, Plano, TX (US)

(73) Assignee: National Polymer International Corporation, Inc. (NPIC)a, Plano, TX (US)

(21) Appl. No.: 17/010,506

(22) Filed: Sep. 2, 2020

(51) Int. Cl. B29C 45/40; B29C 45/17

(52) U.S. Cl. CPC B29C 45/401; B29C 45/1775

(57) ABSTRACT

A separating system for separating or separating items formed in a cavity of an injection molding system to separate them from material in the mold's runner, has a clamp plate for anchoring the separator system. The clamp plate secures a separating plate that supports a first separating pin, either directly or via an actuator. The first separating pin includes a base, a body having a cross-sectional portion, a neck having a cross-sectional portion, and a wedge-shaped tip. The system includes a support plate that supports a cavity plate, where the cavity plate has a first cavity and a first gate that fluidly couples the first cavity to a first runner channel. The separating first separating pin can be articulated to separate a molded material at a boundary between the first gate and the first cavity.

### CLAIM OF PRIORITY, IDENTIFICATION OF RELATED APPLICATIONS

This Provisional patent application claims priority from pending U.S. Patent Application No. 62/878,357 filed on Jul. 25, 2019 entitled INJECTION MOLD WITH INTERNAL CUTTING PIN FOR STARCH-POLYMER MOLDING PROCESSES, to common inventor Steven Ho.

### TECHNICAL FIELD

The invention generally relates to injection molding, and more particularly to injection mold systems, devices and methods used to creating starch-based products.

### Problem Statement and History

### Interpretation Considerations

This section describes technical field in detail and discusses problems encountered in the technical field. Therefore, statements in the section are not to be construed as prior art.

### Discussion of History of the Problem

Since invented in the middle of the 19th century, injection molding processes have been used by manufacturers to create plastic items. And, today, almost every common home and industrial product incorporates some element created via injection molding.

More recently, injection-molded production has moved beyond consumer, automotive, and electronic plastic products, to an even wider-array of products, including foods products made with starch-based polymers. And, fabrication starts with a molding system.

Molding systems include injection runner systems, and ejection systems. The task of an injection runner system is to channel a material from a sprue to mold cavities via gates typically located at the perimeter of each cavity. Ejector systems do just that—they eject a molded product from a mold. Sometimes, feed systems such as heated worm-screw channels move material being molded into the mold, are included as molding systems, but in any event practically all molding systems require a source of pressure to push the material through the injection runner system.

Problematically, parts that are identical across industry designs are sometimes referred to by different names—often based on the producer of the mold. For example, during the process of creating a product, material flows through a mold's ‘runner’ (hollow channels created between two mold plates that touch each other) before flowing into a mold cavity. After the material hardens in the mold, the material becomes both product in the mold cavities as well as waste-product in the runners that is attached to the product. Sometimes this waste material is called a “channel-material-frame” while at other times it is called a “runner.” Other parts of molding systems can be equally prone to confusion. Accordingly, where possible, reference is made not only to context but also to specific piece-part names to differentiate between pieces having similar names.

### Injection Molds

An injection molding system uses a plurality of plates contained within the mold (both “hot runner” and “cold runner” injection molding systems). In operation, the system injects material into the mold through a sprue bushing. The material then flows through runners which lead to one or more gates at one or more mold cavity(ies). The most basic cold runner system consists of two plate molds, which have a parting line separating the two plates. This system results in a mold-products that has the runner and part(s) attached together. Not to be forgotten, the ejection system separates both the runner and part from the mold.

The ejection system typically comprises an ejector plate that articulates a plurality of ejector pins that extend through a support plate and into the core-plate's molding cavities in which a product is formed. Unfortunately, the process of ejection is burdened with problems.

One problem occurs because when the molded product is ejected it is attached to the runner material. This causes the deformation and breakage of molded products. Additionally, sometimes when an ejector system operates before the molded material has cured, the ejector pins create large divots in molded product—causing it to be ruined. Further, even following a successful ejection, the molded material must be separated from the runner material either mechanically or by hand, resulting in additional breakage and production time and expense.

Accordingly, there exist a need for systems, devices and methods that facilitate the separation of a molded product from the runner material.

### Topically Related Publications

U.S. Pat. No. 9,415,535 discloses a multi-stage ejector system for an injection molding apparatus with a plurality of knock out rods extending through an ejector plate for actuating ejector pins in a sequence to reduce energy consumption (FIGS. 1a-1e).

Patent Application 2016/0158983 discloses a perimeter ejector system for an injection molding apparatus wherein the molded material comprises a molded pet treat. The ejector pins are shaped in a manner that conforms to the shape of the mold to further reduce damaged to the molded material.

Patent Application 2018/0220679 discloses a method of making an aerated pet chew composition, where injection molding and/or extruding the composition produces an aerated pet chew (FIGS. 1a-1d).

U.S. Pat. No. 7,579,038 discloses a method of producing a thermoplastic, protein-based, edible injection-molded and introducing the dried extrudate, via a heated vertical injection molding machine, into horizontally-oriented molds having cooling jackets.

Accordingly, there is no injection mold system, device or process that facilitate the separation of a molded product from the runner material, providing for the automation of the process of separating a molded part from its runner. The present invention provide such systems, devices and methods.

### SUMMARY

A separator system for separating (typically by separating) items formed in an injection molding system has a clamp plate for anchoring the separator system. The clamp plate secures a separating plate that supports a first separating pin, either directly or via an actuator. The first separating pin includes a base, a body having a cross-sectional portion, a neck having a cross-sectional portion, and a wedge-shaped tip. The system includes a support plate that supports a cavity plate, where the cavity plate has a first cavity and a first gate that fluidly couples the first cavity to a first runner channel. The separating first separating pin can be articulated to separate a molded material at a boundary between the first gate and the first cavity.

### BRIEF DESCRIPTION OF THE DRAWINGS

Various aspects of the invention and its embodiment are better understood by referring to the following detailed description. To understand the invention, the detailed description should be read in conjunction with the drawings, in which:

FIG. 1 (Prior Art) illustrates an injection mold;

FIG. 2 illustrates a schematic of an injection mold separation system;

FIG. 3 illustrates a mold plate according to the teaching of the invention;

FIG. 4 illustrates the inventive mold plate illustrating the separating portion of the knife protruding therethrough;

FIG. 5 illustrates the inventive mold plate of FIG. 3 illustrating the hidden embedded portions of the knife;

FIG. 6 is a detailed illustration of the knife;

FIGS. 7a and 7b illustrate an array of knives;

FIG. 8 is a system diagram for a polymer injection molding process according to the teachings of the invention; and

FIG. 9 is a flow chart of the operation of the separator process.

### DESCRIPTION OF AN EXEMPLARY PREFERRED EMBODIMENT

### Interpretation Considerations

While reading this section (An Exemplary Embodiment, which describes the exemplary embodiment of the best mode of the invention, hereinafter referred to as “exemplary embodiment”), one should consider the exemplary embodiment as the best mode for practicing the invention during filing of the patent in accordance with the inventor's belief. As a person with ordinary skills in the art may recognize substantially equivalent structures or substantially equivalent acts to achieve the same results in the same manner, or in a dissimilar manner, the exemplary embodiment should not be interpreted as limiting the invention to one embodiment.

The discussion of a species (or a specific item) invokes the genus (the class of items) to which the species belongs as well as related species in this genus. Similarly, the recitation of a genus invokes the species known in the art. Furthermore, as technology develops, numerous additional alternatives to achieve an aspect of the invention may arise. Such advances are incorporated within their respective genus and should be recognized as being functionally equivalent or structurally equivalent to the aspect shown or described.

A function or an act should be interpreted as incorporating all modes of performing the function or act, unless otherwise explicitly stated. For instance, sheet drying may be performed through dry or wet heat application, or by using microwaves. Therefore, the use of the word “paper drying” invokes “dry heating” or “wet heating” and all other modes of this word and similar words such as “pressure heating”.

Unless explicitly stated otherwise, conjunctive words (such as “or”, “and”, “including”, or “comprising”) should be interpreted in the inclusive and not the exclusive sense. Like numerals indicate like parts unless otherwise indicated.

As will be understood by those of the ordinary skill in the art, various structures and devices are depicted in the block diagram to not obscure the invention. In the following discussion, acts with similar names are performed in similar manners, unless otherwise stated. Further, trademarks shown as Registered® are the property of their respective owners and no claim or limitation is made thereto.

The foregoing discussions and definitions are provided for clarification purposes and are not limiting. Words and phrases are to be accorded their ordinary, plain meaning, unless indicated otherwise.

### Description of the Drawings, a Preferred Embodiment

### Introduction

The present invention relates to separator system for an injection molding apparatus. The separator system separates the molded material from the runner it is attached to during the manufacturing process. The separating occurs immediately after the molded material has completely filled the mold cavity, without creating a torn edge as is often the case when a molded item is removed from the runner. This has the added benefit of making the molded item easier to remove from the cavity. The separator system has broad applicability for a variety of molded materials, and is discussed below in a non-limiting context of a molded pet treat.

### Description of the Figures

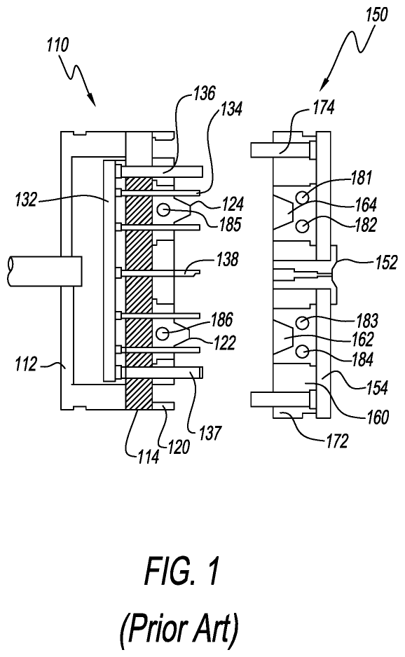

FIG. 1 (Prior Art) illustrates one common injection mold structure (or “mold”). It is well understood in the injection molding arts that many variations of mold structures are available in the art, and FIG. 1 is provided as an introduction to mold terminology, and is not limiting in any way. The mold structure comprises of two primary components: an ejector mold 110 and an injection mold 150.

The ejector mold 110 is anchored by a stationary clamp plate 112, and provides the foundational structure for the ejector mold 110. A support plate 114 (also called a base plate) is coupled to the clamp plate 112, and supports a core plate 120. The core plate 120 is the plate that comprises the elements that provide the cavities and the channels (also called runners) in which the material being molded flows. The core plate 120 also has a first core 122 and a second core 124 that provide approximately half of the cavity in which a material is formed into a product, part, or item (collectively “item” or “items”). The core 120 also has holes (not shown) therein through which pass a variety of pins as described below.

The ejector mold 110 also includes an ejection system, which comprises an ejection plate 132 that articulates between the clamp plate 112 and the support plate 114 via an actuation system (not shown, but readily understood by those skilled in the present art). A plurality of ejector pins 134 are coupled to the ejection plate 132, pass through the support plate 114 and the core plate 120, and when ejecting a molded item also pass into one or more mold cores. Also attached to the ejection plate 132 are two ejector guide pins 136, 137.

The ejector guide pins 136, 137 typically extend further away from the ejection plate 132 than the ejector pins 134 in order to guide the ejector pins 134 through the support plate 114 and core plate 120 without damage. The ejector guide pins 136, 137 also abut a core plate 160 in the unlikely event that the ejection plate 132 moves toward the cavities while the injection mold 150 is mated with the ejector mold 110, thus further protecting the more fragile ejector pins 134. Additionally illustrated as attached to the ejection plate 132 is a sprue grabbing pin 138 that is notched, as known in the present art, in order to pull a material sprue (and thus all formed material) away from the injection mold 150.

The injection plate 150 is anchored by a movable plate 154, which is also functionally similar to the clamp plate 112. A cavity plate 160 is secured to the movable plate 154, and supports a first cavity 162 that mates with the first core 122 to create a first formed cavity there-between, and a second cavity 164 that mates with the second core 124 to create a second formed cavity there-between.

The cavity plate 160 also supports leader pins 172, 174 that pass through and protrude from the cavity plate 160 so that when the injection mold 150 moves forward to mate with the ejector mold 110, the molds mate properly. Also illustrated as circular holes in both the injection mold 150 and the ejection mold 110 are a plurality of cooling channels (also called cooling lines) 181-186. Lastly material to be molded enters the mold structure 100 at a sprue bushing 152, where it flows into channels, through gates and into the mold cavities themselves.

In the present art, part and component names are sometimes manufacturer specific; however, the use of names herein is not intended to and does not evoke a limitation to a specific manufacturer.

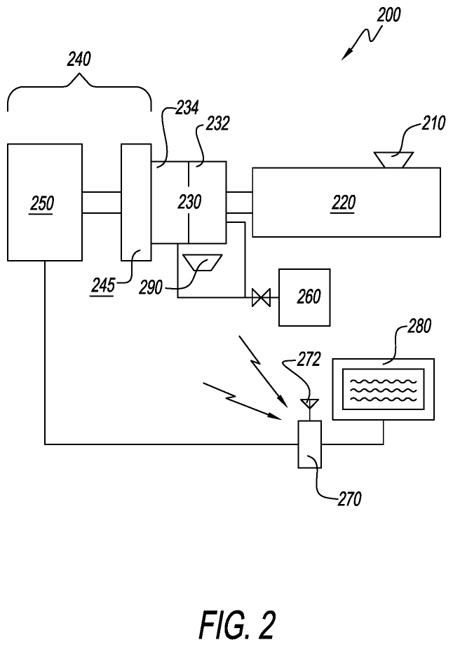

FIG. 2 illustrates a schematic of an injection mold separation system (“system”) 200, where each item identified herein comprises a component of the system 200. The system 200 includes a material feed system 210, such as a hopper, that provides fresh material, such as polymer food starches, to a heated worm-screw system 220.

In turn, the heated worm-screw system 220 forces material into a mold 230 having a stationary injection mold 132 and an articulating ejector mold 134. The ejector mold 134 is coupled to a motion system 240 which includes a movable platen 245 and a clamping cylinder 250. The platen 245 is moved back-and-forth relative to the stationary injection mold 132 by the clamping cylinder 250 which may be hydraulically or mechanically actuated. Further, a cooling system 260 provides circulating coolant to the mold 230.

To control the movement of the mold 230, the injection mold 232 and the ejection mold 234, a control system 270 is provided. The control system 270 includes a processor having a memory, a memory, input/output (I/O) plugs, and wireless communication systems and antennas 272 that enable a user to program and/or otherwise control the movement of the ejector mold 234, the injection mold 232, coolant via the cooling system 260, an injection mold separation system, as well as the movement of any material, coolant or other viscous material through the system 200.

Additionally, the control system 270 monitors and receives input from each of the system components (210, 220, 230, 240, 250, 260, and 270), and uses these inputs to compute and calculate functions in response to those inputs, and then directs any appropriate system components, or system operator(s), to take actions as appropriate to address concerns such as safety, manufacturing, and the like.

Further, a screen display 280 provides a user the ability to observe control system 270 outputs, as well as to monitor the input of commands and instructions into the control system 270. In one embodiment, the commands and instructions, inputs, computations, and outputs are in the form of software code that define a computer-implemented inventive method that achieves a technical effect. A separate collection system 290 is provided for catching, capturing and/or collecting molded items such as pet treats, as well as waste product such as runners and/or sprues.

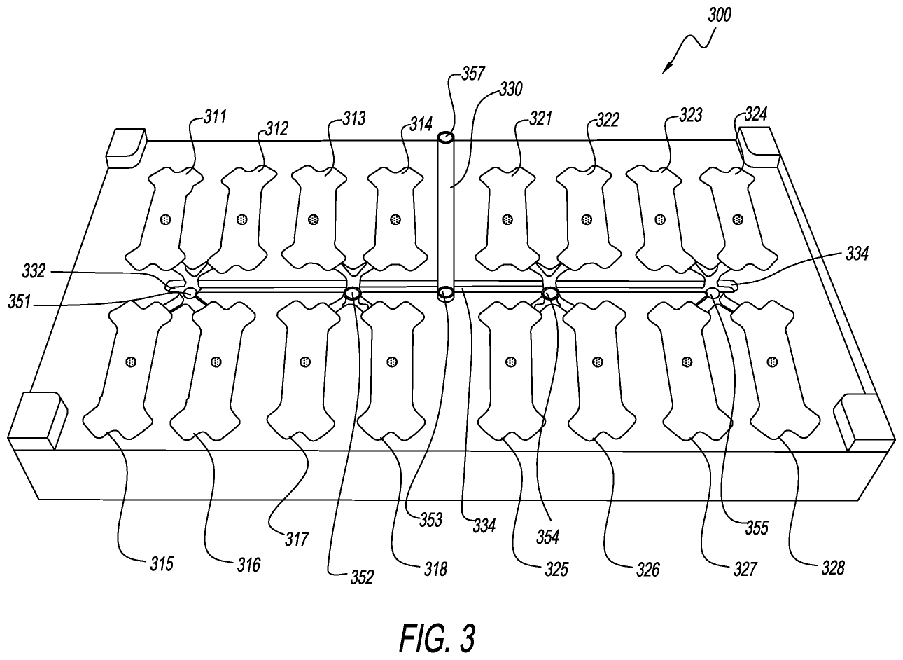

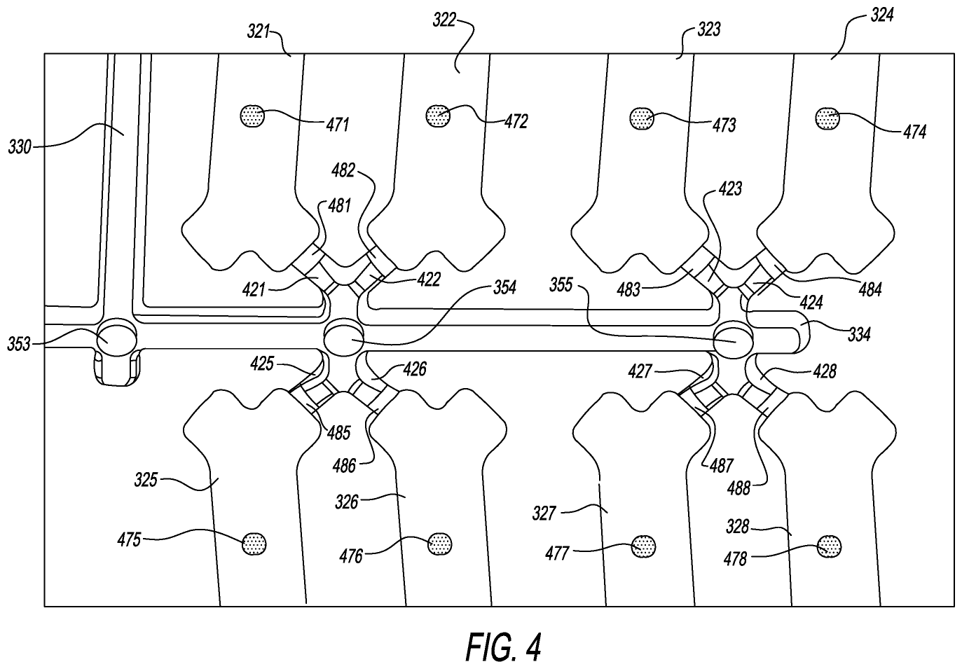

FIG. 3 illustrates a schematic of a cavity plate 300 according to the teaching of the invention. The cavity plate 300 includes a plurality of dog-bone shaped cavities 311-318 and 321-328. A sprue 330 is a conduit into which hot material flows from a nozzle 357/sprue bushing (not shown) before first passing through runner channels 332, 334, then through a plurality of gates, each gate providing a channel into one of the cavities 311-318 and 321-328. A plurality of ejector pin-holes/ejection holes 351-366 provide access for runner ejector pins (discussed later) that eject the material runners and sprue, while additional ejection holes (also discussed later) are provided in the mold cavities to eject a molded item from the cavities. Further, separator holes (hereinafter “separating-pin holes”) are also provided at each gate, as discussed in FIG. 4.

FIG. 4 is a close-up schematic of the cavity plate 300, and illustrates the sprue 330, the runner channels 332, 334 as well as selected cavities 321-328 in more detail. In particular, it is seen that the runner 334 flows through gates 421-428 into a cavity 321-328. As will be discussed in more detail below, each gate 421-428 has a separating-pin hole (or slot) 481-488 a separating pin articulates. In particular, when articulated, a separator, such as a tip of each of a separating pin protrudes through the separating-pin holes to separate each molded items at the location of each gate 481-488 such that each separating pin protrudes completely at the location each gate meets its corresponding cavity.

Also seen in FIG. 4 more clearly are runner ejection holes 353-355 as well as a plurality of cavity ejection holes 471-478 through which ejector pins articulate. The runner channels, cavities, gates, ejector-pin holes, and separating-pin holes are similarly situated throughout the mold of the present invention.

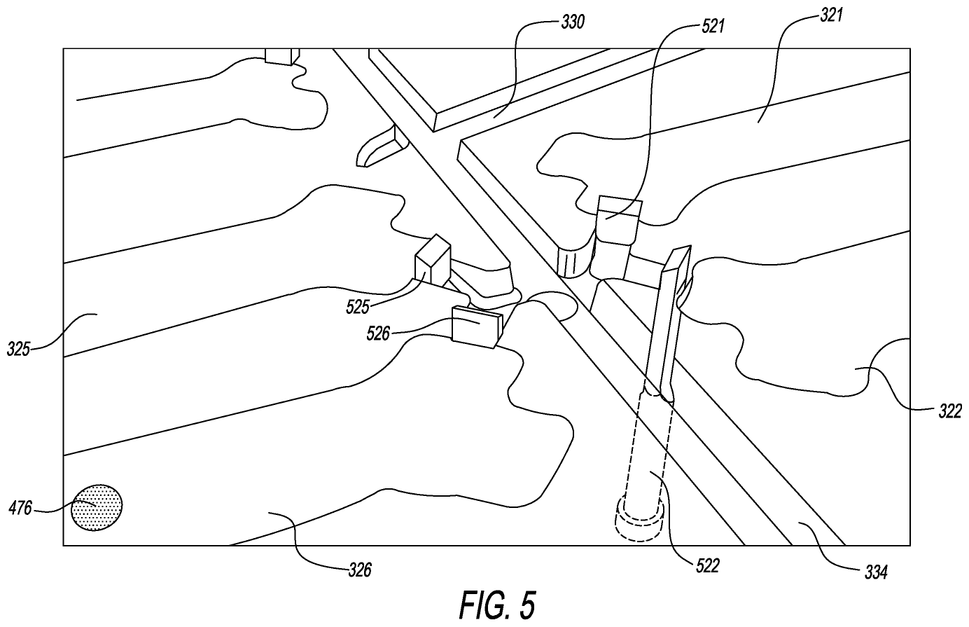

FIG. 5 illustrates a close-up of a location where a runner 334 intersects with four gates 421, 422, 425 and 426 (the gates are illustrated and numbered in FIG. 4). Separating pins 521, 522, 525 and 526 are shown in a fully extended separating position. In the fully extended separating position, any material item in a cavity 321, 322, 325 and 326 would be separated away from the material runner is was formed with.

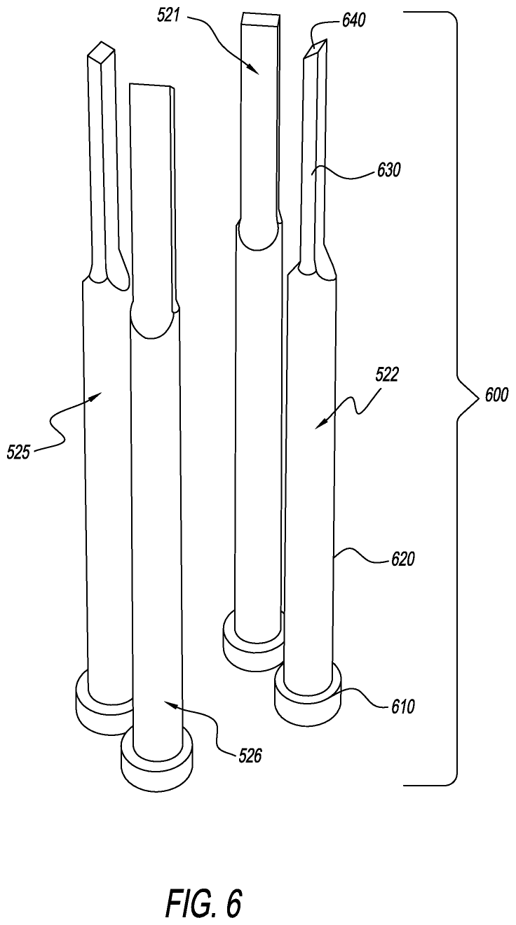

FIG. 6 illustrates an array 600 of separating pins 521, 522, 525 and 526. Examining separating pin 522 more closely it is seen that each separating pin has a base 610, a generally cylindrical elongated body 620 that tapers at its distal end into a polygon-shaped neck 630 that terminates as a wedged separating tip 640.

The base 610 and body 620 have a form and operate similarly to corresponding parts of an ejector pin. The neck 630 that tapers to tip 640, however, is shaped to accommodate the width and geometry of both its corresponding gate (here, 422) as well as the corresponding mold cavity (here, 322). Thus, the tapered head 640 provides a clean separation of each material item formed in the mold cavity 322.

Although not illustrated in FIG. 6, a separating pin base, body, neck and tip may each be made of different materials, and may be separable from each other as desired to accommodate longevity of a tip, overall cost of production, speed of change-out, resiliency, and other considerations. Further, a separating-board piece of a selected material, such as heat-resistant nylon, may be embedded in a cavity mold opposite of each tip of each separating pin to increase the life and effectiveness of a separating pin.

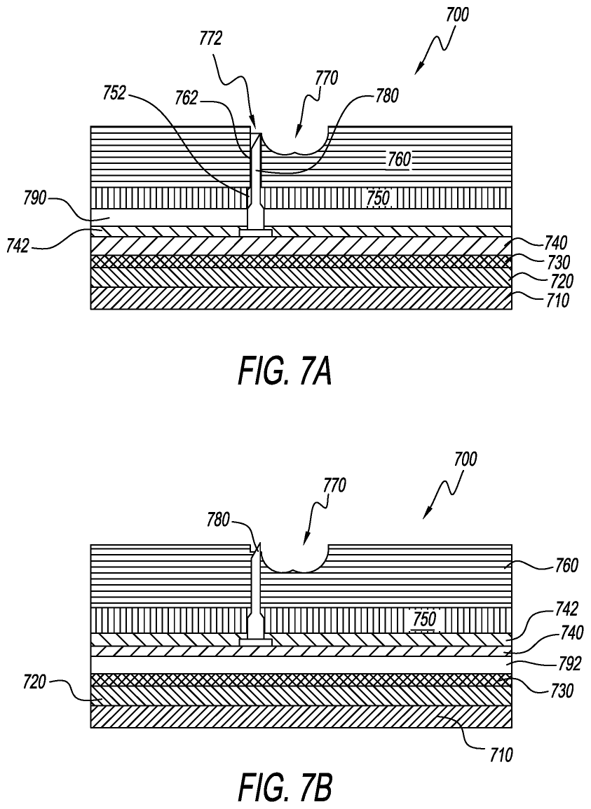

Now referring to FIGS. 7A and 7B which illustrate sectional views of a separator system during a separation (or separating) process of a molded starch-based pet treat. FIG. 7A shows a sectional view of a separator system 700 in an initial position. The separator system 700 comprises a clamp plate 710 for anchoring the separator system 700, an ejector plate 720 that supports and is for articulating a plurality of ejector pins as is well-known in the injection molding arts, and an ejector-retainer plate 730 that secures ejector pins onto the ejector plate 720 in any manner well-known in the injection molding arts (this view does not illustrate ejector pins, thus none are shown).

A separating plate 740 supports and is for articulating separating pins such as a separating pin 780, which is in turn held to the separating plate 740 by a separating retainer plate 742 (note how the head of the separating pin contours to the separating plate). A gap 790 provides space through which the separating plate 740, separating retainer plate 742, and separating pin 780 may traverse when articulated or retracted.

A support plate 750 provides structure for a cavity plate 760 which contains a cavity 770, a gate 772 that is in fluid communication with the cavity 770 as well as a runner channel (not shown). The support plate 750 has a support plate separating channel 752 shaped substantially similar to and slightly larger than a body cross-sectional portion of the separating pin 780. Similarly, the cavity plate 760 also has a cavity plate separating channel 762 therein, which is shaped substantially similar to and slightly larger than a neck cross-sectional portion of the separating pin 780. Further, the separating pin 780 can likewise be said to be accommodated within the separating channels 752, 762. Both the separating plate 740 and the separating retainer plate 742 are adapted to move towards the cavity plate 760 during a separating.

FIG. 7B shows a sectional view of the separator system 700 during separating of a molded item. During separating, the separating plate 740 moves in unison with the separating retainer plate 742 towards the cavity plate 760, which in turn actuates the separating pin 780 to extend through the gate 772 to the position shown in FIG. 7B.

In particular, the tip of the separating pin 780 is wedged to a sharp edge blade and the sharp edge is configured to separate at the boundary of the pet treat, stated another way, the leading portion of the edge separates material in the gate at a gate-cavity boundary 772/770 boundary, such that the pet treat is left with a smoother, cleaner edge than with prior art techniques for separating the pet treat from a runner.

Although not shown in FIG. 7A-7B, following the separating of the pet treat, a control system may actuate the ejector plate 720 which would then articulate in unison with the ejector retainer plate 730 to articulate ejector pins (not shown) to push and remove a molded pet treat (not shown) from the cavity 770. Ejecting may be accomplished via safety return pins or push back pins to reposition the separating pin(s) and ejector pins to their starting positions, following ejection of the molded material through a molding cycle. Further it is known in the art to ‘invert’ the plates that are in motion—that is to say that a cavity plate may move towards the separating plate to achieve a substantially similar effect, and such articulation is within the scope of the invention.

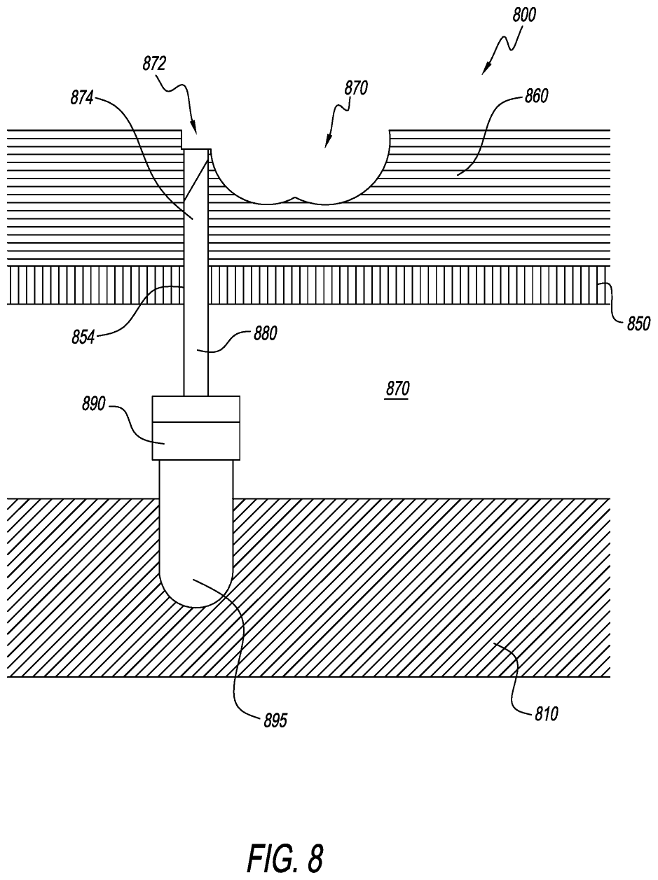

FIG. 8 illustrates a sectional view of a separator system 800 comprising a separating pin 880 driven by an actuator 895, at an initial position. The separator system 800 comprises a cavity plate 860 having a cavity 870 therein for forming a molded pet treat and a gate 872 for transporting (flowing) material into the cavity 870. The cavity plate 860 is supported by a support plate 850. At least one separating pin 880 can be actuated by an actuator to extend through a support plate channel 854, a cavity plate channel 874, and the gate 872 at an edge of the cavity 870 in order to smoothly separate the molded pet treat.

The actuator comprises a cylinder 895 fixed to a clamp plate 810 as well as a movable piston rod 890 extending from the cylinder 890 to actuate the separating pin 880. Although not shown, the actuator may also include electrical connections and/or wireless communication systems so that the actuator may communicate with a control system.

During actuation, the separating pin 880 is actuated by the actuator to extend through the gate 872 at an edge of the pet treat being formed. Ejector pins may be separately articulated in a similar manner to ejected the pet treat from the cavity 870. The piston rod 890 begins to extend from the cylinder 895 during initiation of actuation of separating pin 880. Although not illustrated, it is understood by those of skill in the injection mold arts upon reading this disclosure that ejector pins may be articulated in a like manner to remove the pet treats from the mold cavity 870.

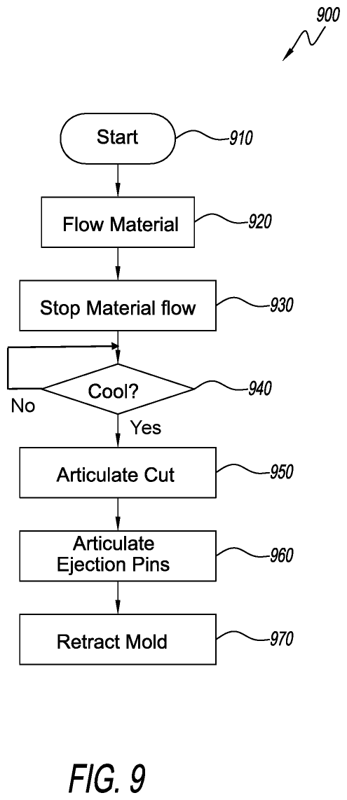

FIG. 9 is a flow diagram of a separation algorithm 900 for automating a pet treat production cycle that incorporates a separator system. The separation algorithm 900 begins with a start act 910 in which an electronic signal is generated in a control system such as the control system 270, and communicated to the respective parts of a mold material separator system such as the system 200. Common control systems include computing devices such as processor-based platforms that run software including Windows®, iOS®, Linux®, and Android®, for example. Accordingly, the separation algorithm 900 may be implemented as software, including common software such as C++, basic, or various proprietary software systems known in or to be developed in the art.

Next, in a flow material act 920, the separation algorithm 900 flows material by instructing a worm-screw system, such as the worm-screw system 220 which includes at least one worm-screw, to articulate and dispense a pre-determined amount of starch-based material into a mold such as the mold 230. After the pre-determined amount of starch-based material has entered the mold 230, the flow ends in a stop material flow act 930.

During a cooling query 940, the separation algorithm 900 queries sensors (not shown) in or on the mold 230 to determine if the material in the mold 230 has cooled sufficiently to separate. After the separation algorithm 900 detects that at least the warmest allowable temperature for a separation has been reached, then the separation algorithm proceeds to an articulate separation act 950.

In the articulate separation act 960 the separation algorithm 900 sends an electronic signal to activate a motion system, such as the motion system 240 that comprises platen 245 and clamping cylinder 250, but which may also comprise actuators such as the actuator 890, 895, and may be moved or articulated in other manners known in the art, and which are foreseeable or unforeseeable. When the motion system is activated, it moves in a manner so as to articulate a separating plate having separating pins (or knives) mounted thereto, or actuator(s) having separating pins coupled thereto, to separate the material inside the mold, and then may either withdraw the separating pin(s) to the starting position before or after ejector pins (if any) are articulated.

Accordingly, next, in an articulate ejector pins act 960, the separation algorithm 900 generates an electronic signal to motivate an ejection-pin system to articulate in a manner known in the art so as to eject the items molded (or “created”) as well as excess runner material from the mold. The separation algorithm 900 next retracts separating pins and ejector pins by sending electronic signals to their respective systems to have them articulate. By these signals, in one embodiment, the separating pins are refracted before the ejector pins articulate, in another embodiment, the separating pins are retracted in unison with the ejector pins, and in another embodiment, the separating pins are retracted after the ejector pins have retracted.

Although the invention has been described and illustrated with specific illustrative embodiments, it is not intended that the invention be limited to those illustrative embodiments. Those skilled in the art will recognize that variations and modifications can be made without departing from the spirit of the invention. Therefore, it is intended to include within the invention, all such variations and departures that fall within the scope of the appended claims and equivalents thereof.

I claim:

1. In an injection-molding system, a separator system for separating items formed in an injection mold, the separator system comprising:
a clamp plate for anchoring the separator system, the clamp plate securing
an ejector plate that supports and articulates a first ejector pin, the ejector plate being movable relative to the clamp plate;
an ejector-retainer plate secured to the ejector plate such that the first ejector pin is secured to the ejector plate;
a separating plate that supports and articulates a first separating pin, the first separating pin being secured to the separating plate by a separating retainer plate, and the first separating pin having a base, a body having a cross-sectional portion, a neck having a cross-sectional portion, and a wedge-shaped tip;
a support plate providing structure that supports a cavity plate, the support plate comprising a support plate separating channel shaped similar to and slightly larger than the body cross-sectional portion of the first separating pin, the cavity plate comprising
a first cavity, and
a first gate that fluidly couples the first cavity to a first runner channel;
the cavity plate also comprising a cavity plate separating channel therein which is shaped similar to and slightly larger than the cross-sectional portion of the neck; and
the separating plate and the separating retainer plate being adapted to move towards the cavity plate during a separating.

2. The first separating pin of claim 1 wherein the body is generally cylindrical.

3. The first separating pin of claim 1 wherein the neck is has a polygonal shape.

4. The first separating pin of claim 1 wherein the tip terminates as a sharp-edged blade.

5. The first separating pin of claim 1 wherein the body is generally cylindrical and tapers into the neck, the neck having a polygonal shape and terminating at the tip, the tip being wedge-shaped.

6. The first separating pin of claim 1 having a shape that contours to a channel formed in the cavity plate and the first cavity.

7. The first separating pin of claim 1 wherein the neck tapers to the tip, and the tip is shaped to accommodate the geometry of both the first gate and the first cavity.

8. The separator system of claim 1 wherein the tip of the separating pin is positioned for articulation in the first gate at a first gate-first cavity boundary.

9. The separator system of claim 1 being adapted to mold a starch-based polymer material.

10. The separator system of claim 1 further comprising:
a second separating pin secured to the separating plate by the separating retainer plate, the second separating pin having a base, a body having a cross-sectional portion, a neck having a cross-sectional portion, and a wedge-shaped tip; and
the support plate comprising a second support plate separating channel shaped similar to and slightly larger than the body cross-sectional portion of the second separating pin, and the cavity plate comprising a second cavity;
the cavity plate comprising a second cavity and a second gate that fluidly couples the second cavity to the first runner channel; and
the second separating pin tip is positioned for articulation in the second gate at a second gate-first cavity boundary.

11. In an injection-molding system, a separator system for separating items formed in an injection mold, the separator system comprising:
a clamp plate for anchoring the separator system, the clamp plate securing
a separating plate that supports and articulates a first separating pin, the first separating pin being secured to the separating plate by a separating retainer plate, and the first separating pin having a base, a body having a cross-sectional portion, a neck having a cross-sectional portion, and a wedge-shaped tip;
a support plate providing structure that supports a cavity plate, the support plate comprising a support plate separating channel shaped similar to and slightly larger than the body cross-sectional portion of the first separating pin, the cavity plate comprising
a first cavity, and
a first gate that fluidly couples the first cavity to a first runner channel;
the cavity plate also comprising a cavity plate separating channel therein which is shaped similar to and slightly larger than the cross-sectional portion of the neck; and
the separating plate and the separating retainer plate being adapted to move towards the cavity plate during a separating.

12. In an injection-molding system, a separator system for separating items formed in an injection mold, the separator system comprising:
a clamp plate for anchoring the separator system, the clamp plate securing
a separating plate that supports a first actuator, the first actuator is adapted to articulate a first separating pin, the first separating pin having a base, a body having a cross-sectional portion, a neck having a cross-sectional portion, and a wedge-shaped tip;
a support plate providing structure that supports a cavity plate, the support plate comprising a support plate separating channel shaped similar to and slightly larger than the body cross-sectional portion of the first separating pin, the cavity plate comprising
a first cavity, and
a first gate that fluidly couples the first cavity to a first runner channel; and
the cavity plate comprising a cavity plate separating channel which is shaped similar to and slightly larger than the cross-sectional portion of the neck.
